(19) United States
(12) Patent Application Publication
(10) Pub. No.: US 2017/0229217 A1
(43) Pub. Date: Aug. 10, 2017

(54) SPLIT SLEEVING TOOL

(71) Applicant: CommScope Technologies LLC, Hickory, NC (US)

(72) Inventors: Scott C. Kowalczyk, Savage, MN (US); Mario Lerma Enriquez, Delicias (MX); Soutsada Vongseng, Chanhassen, MN (US); Jaime Gonzalez, Prior Lake, MN (US); Cyle D. Petersen, Belle Plaine, MN (US)

(21) Appl. No.: 15/424,450

(22) Filed: Feb. 3, 2017

Related U.S. Application Data
(60) Provisional application No. 62/291,405, filed on Feb. 4, 2016.
(60) Provisional application No. 62/400,971, filed on Sep. 28, 2016.

(51) Int. Cl. H01B 13/06

(52) U.S. Cl. CPC H01B 13/062

(57) ABSTRACT

The present disclosure relates to a cable sleeving tool for applying a split-sleeve over a cable structure. The cable sleeving tool includes an inner guide member defining an inner passage for receiving a cable structure desired to be sleeved. The inner passage extends along a passage axis between an upstream end of the inner guide member and a downstream end of the inner guide member. The inner guide member also includes an inner surface defining the inner passage and an outer sleeve expansion surface for expanding the split sleeve. The cable sleeving tool also includes an outer guide member that surrounds at least a portion of the inner guide member. The outer guide member includes a sleeve containment surface that opposes the outer sleeve expansion surface. The outer sleeve expansion surface and the sleeve containment surface cooperate to define a sleeve passage having a transverse cross-sectional shape that curves generally about the passage axis.

### CROSS REFERENCE TO RELATED APPLICATION

This application claims the benefit of U.S. Provisional Application No. 62/291,405, filed Feb. 4, 2016, and U.S. Provisional Application No. 62/400,971, filed Sep. 28, 2016, the disclosures of which are hereby incorporated herein by reference.

### TECHNICAL FIELD

The present disclosure relates generally to tooling for manufacturing cabling. More particularly, the present disclosure relates to tooling for installing split sleeves over cables or cable bundles.

### BACKGROUND

Split sleeves are used to protect the exterior surfaces of cables and cable bundles. A typical split sleeve has a longitudinal slit or seam that extends throughout the length of the split sleeve. The split sleeve can be flexed open to allow a cable or cable bundle to be inserted therein. Generally, the split sleeve has a construction within inherent elasticity that biases the split sleeve from the open configuration toward a closed configuration. A common construction for a split sleeve includes a mesh or braid of interwoven plastic and or fiberglass strands. Tools exist for installing a split sleeve over a cable or cable core. However, improvements are needed in this area.

### SUMMARY

Some aspects of the disclosure are directed to a sleeving tool including a tool base; and an insert arrangement. The insert arrangement includes a mounting arrangement; and a replaceable insert held by the mounting arrangement. The replaceable insert includes an inner conduit defining a passage. The replaceable insert also includes a guiding member that defines a channel between the inner conduit and the guiding member.

Other aspects of the disclosure are directed to a sleeving system including a first spool holding a bundle of optical cables; a second spool holding a length of sleeve; a sleeving tool configured to automatically apply the sleeve around the bundle of optical cables to form a sleeved cable; and a take-up spool that holds the sleeved cable.

In certain examples, the sleeving tool includes a mounting arrangement configured to receive one of a plurality of replaceable inserts. Each replaceable insert is configured to receive a particular size of the sleeve and bundle of optical cables.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a transverse cross-sectional view of a sleeved optical cable bundle;

FIG. 2 is a schematic diagram of a coiling system including a sleeving tool;

FIG. 3 is a perspective view of the an example sleeving tool in accordance with the principles of the present disclosure mounted on a frame;

FIG. 4 is a perspective view of the frame of FIG. 3 with the sleeving tool removed;

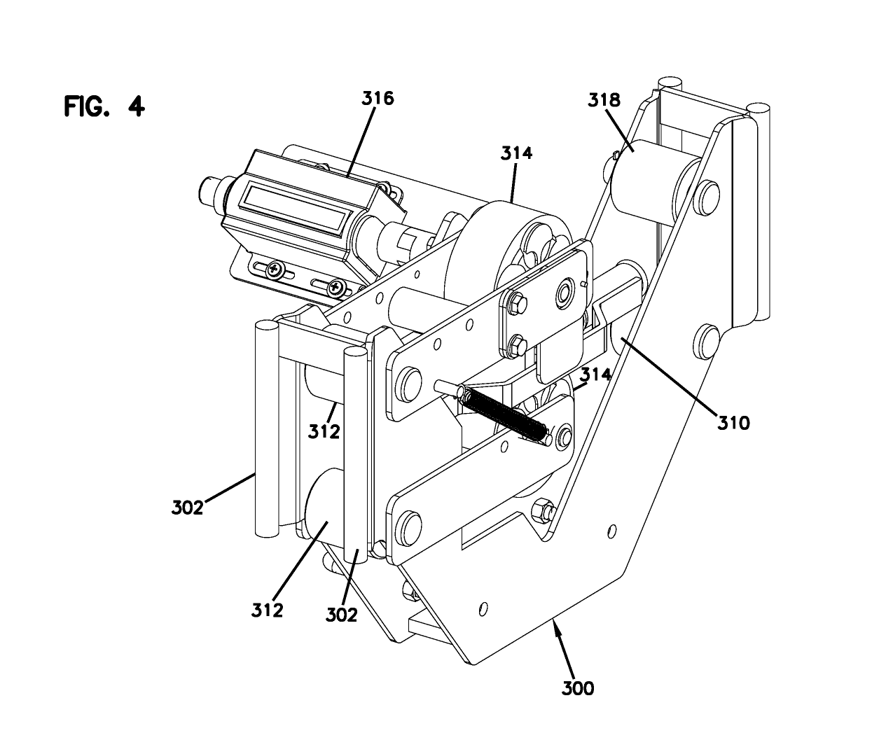

FIG. 5 is a side view of the combination of the sleeving tool and frame of FIG. 3;

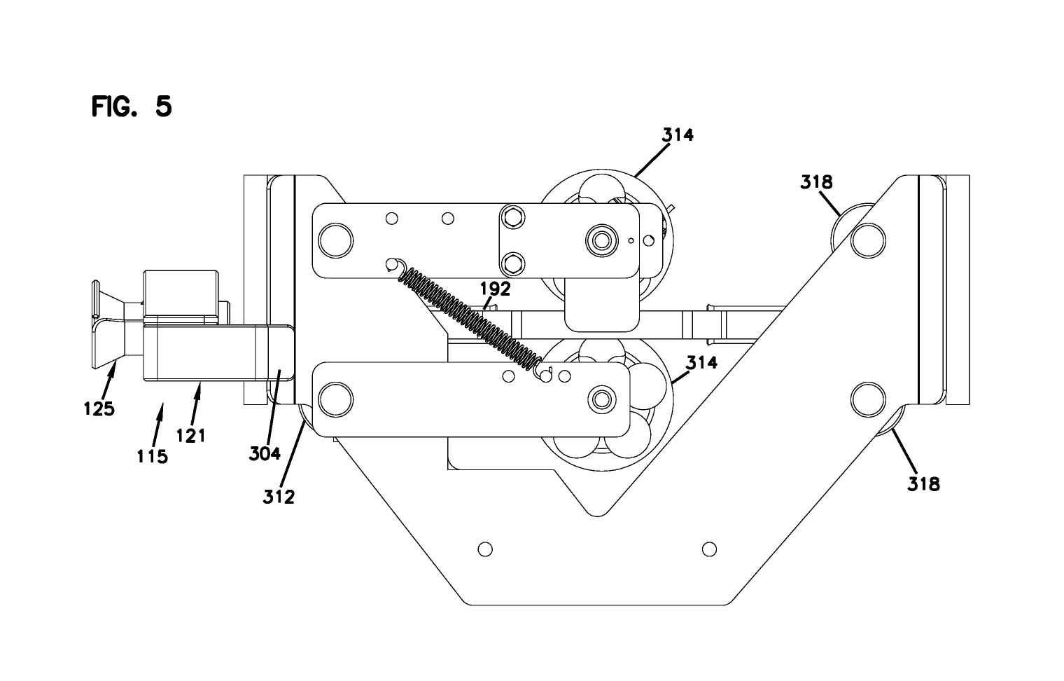

FIG. 6 is an end view of the sleeving tool and frame of FIG. 3;

FIG. 7 is a top view of the sleeving tool and frame of FIG. 3;

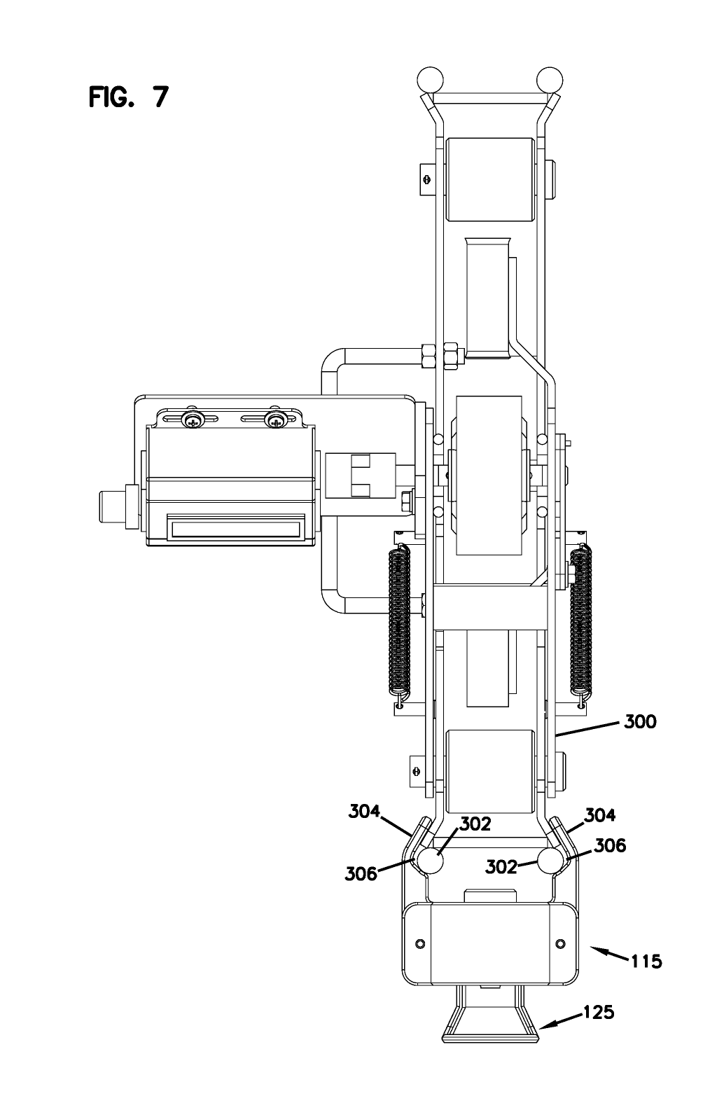

FIG. 8 is a perspective view of the sleeving tool of FIG. 3 shown in isolation from the frame;

FIG. 9 is an exploded view of the sleeving tool of FIG. 8;

FIG. 10 is an exploded view of a portion of the sleeving tool of FIG. 9;

FIG. 11 is a cross-sectional view of the sleeving tool of FIG. 8 taken along a longitudinal sectional plane;

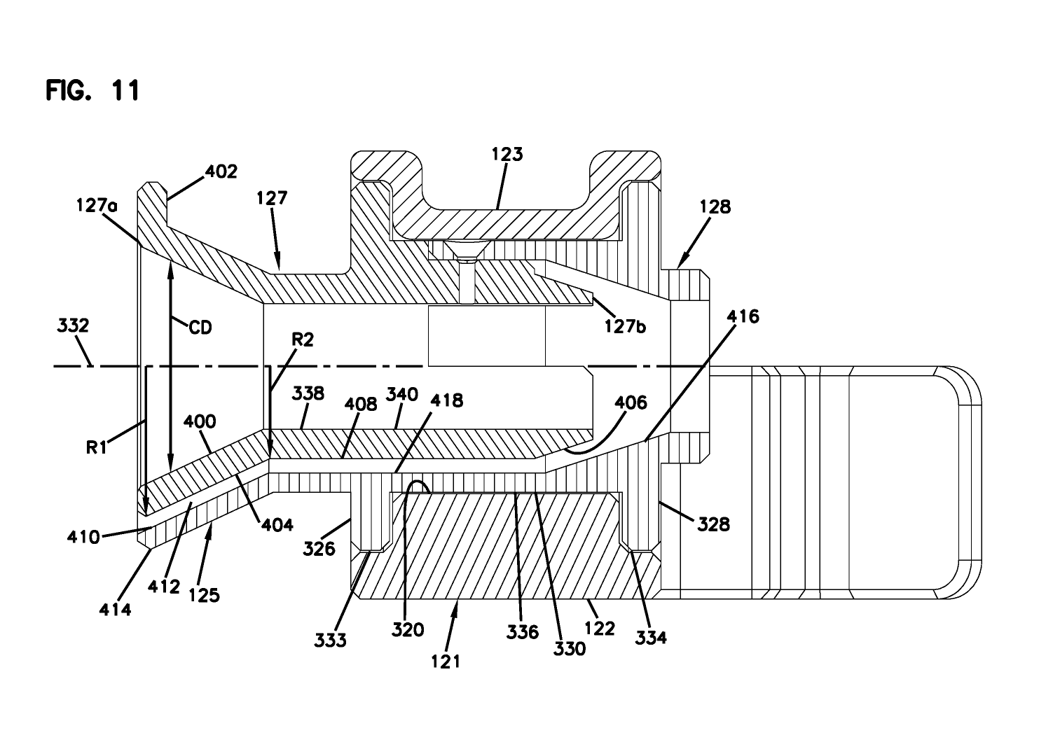

FIG. 12 shows the sleeved cable bundle of FIG. 1 with the split sleeve flexed to an open configuration;

FIG. 13 shows the sleeved cable bundle of FIG. 12 with the split sleeve flexed to an intermediate open configuration;

FIG. 14 is an exploded view of another sleeving tool in accordance with the principles of the present disclosure, the sleeving tool is configured to insure that an underlap portion of the split sleeve seam tucks under an overlap portion of the split sleeve seam during the sleeving process;

FIG. 15 is another exploded view of the sleeving tool of FIG. 14; and

FIG. 16 shows the sleeved cable bundle of FIG. 1 passing through the sleeving tool of FIGS. 14 and 15 with the underlap portion of the split sleeve seam shown returned (e.g., laid down, moved down, etc.) to the closed position prior to the overlap portion of the split sleeve being allowed to return to the closed position (i.e., the overlap portion is retained in the flexed-open orientation while at the same time the underlap portion is allowed to return to the closed position).

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

The present disclosure is directed to a tool and coiling process for applying a split sleeving over an optical cable. In certain implementations, the optical cable is a pre bundled optical cable. The tool includes a changeable insert that can be selected based on the size, shape, or other feature of the cable to be placed in the sleeve.

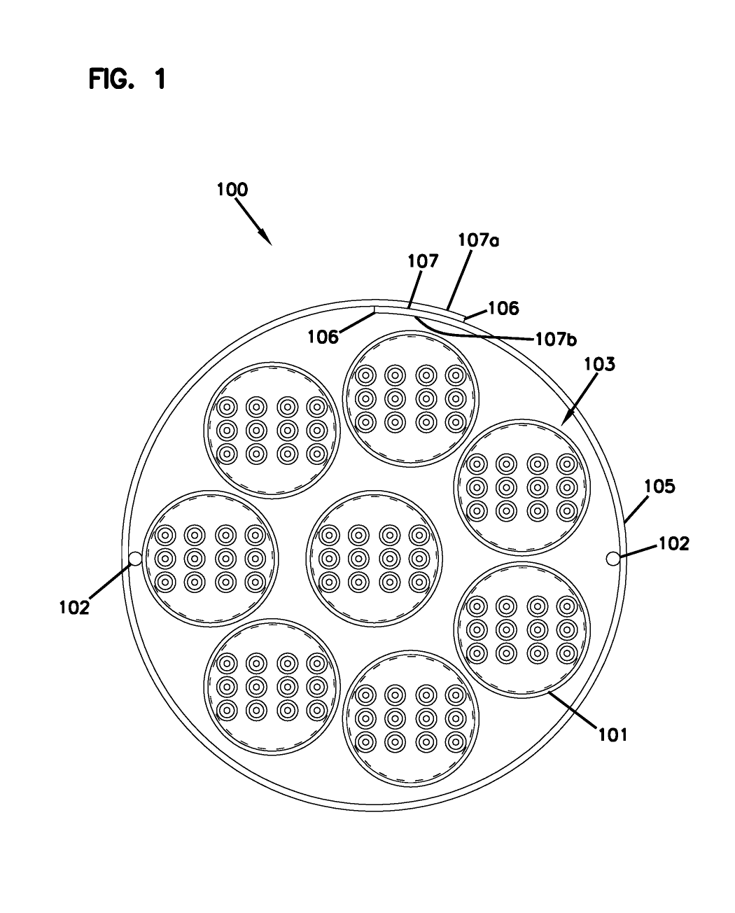

FIG. 1 illustrates a bundle 103 of optical cables 101 disposed within a sleeve 105 to form a sleeved cable arrangement 100. The bundle 103 of optical cables 101 includes one or more optical cables 101. In certain implementations, the bundle 103 includes two or more optical cables 101 held together using a binding 102 (e.g., twine, tape, aramid yarn, etc.) helically wound around the cables 101 to bundle the cables together. In certain examples, the cables 101 can be stranded relation to one another (e.g., in an 5-2 strand pattern). In some examples, the sleeve 105 has overlapping edges 106 to fully enclose the bundle 103 of cables 101 (e.g., see FIG. 1). In other examples, edges of the sleeve 105 meet at a butt-end connection. In still other examples, the sleeve 105 does not fully enclose the bundle 103 of cables 101.

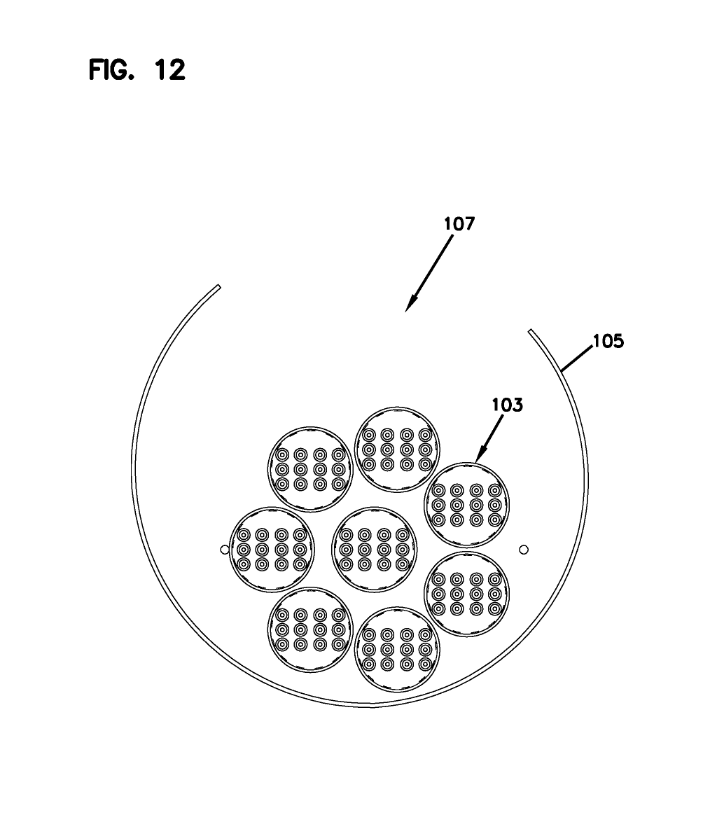

It will be appreciated that the sleeve 105 is a split sleeve having a longitudinal slit or seam 107 that extends throughout the length of the sleeve 105. The seam 107 can be a butt-seam or an overlapped seam. As depicted, the seam 107 is an overlapped seam including an overlap portion 107a that extends over an underlap portion 107b. The seam 107 allows the sleeve 105 to be moved from a closed position (see FIG. 1) to an open position (see FIG. 12). In the closed position, the sleeve 105 is configured to fully surround a cable or cable bundle contained therein. In the open position of FIG. 12, a cable or cable bundle can be readily inserted into or removed from the sleeve 105. It will be appreciated that the sleeve 105 has an inherent elastic construction that causes the sleeve 105 to be biased toward the closed position. Thus, the closed position is the natural resting state of the sleeve 105. In certain examples, the sleeve 105 can have a corrugated plastic configuration. In other examples, the sleeve 105 can have a fabric construction such as a mesh or braid. In certain examples, the sleeve 105 can be formed from a braid of interwoven plastic or fiberglass strands. Example split sleeves are disclosed in the U.S. Pat. Nos. 5,186,992; 6,341,626; 6,491,067; 8,002,781; and 9,091,002, which are hereby incorporated by reference in their entireties. Other split sleeve designs are disclosed by U.S. Patent Publication Nos. 2003/0168248; and 2013/0228248, which are also hereby incorporated by reference in their entireties.

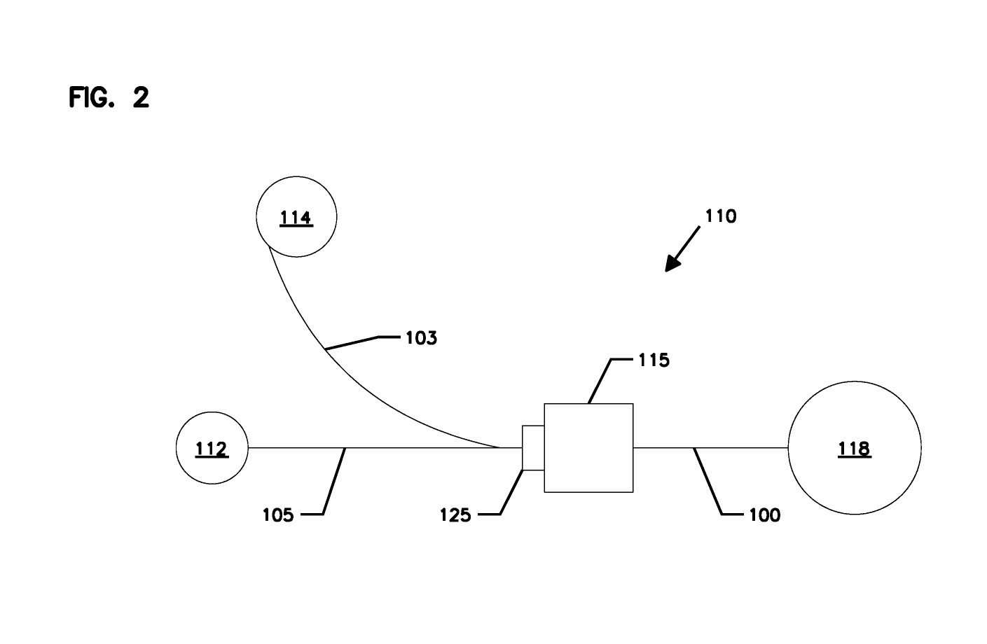

FIG. 2 illustrates a coiling system 110 configured to automatically apply the sleeve 105 over the bundle 103 of cables 101. A first coiling spool 112 holds a long length of the sleeve 105. A second coiling spool 114 holds a long length of the bundle 103 of cables 101. First ends of the sleeve 105 and the bundle 103 of cables 101 are routed to a sleeving tool 115, which places the bundle 103 of cables 101 within the sleeve 105 to form a sleeved cable arrangement 100. The tool 115 outputs the sleeved cable arrangement 100 to a take-up spool 118. The take-up spool 118 can be a driven spool that is rotated by a motor or other drive mechanism so as to pull the sleeve 105 and the cable bundle 103 through the sleeving tool 115.

The sleeving tool 115 is configured to accept cable bundles 103 and sleeves 105 of various sizes. For example, the sleeving tool 115 may include an insert arrangement which allows one of a plurality of replaceable inserts 125 can be installed and utilized. Each insert 125 can be sized to receive a cable bundle 103 of a particular size (e.g., diameter). In certain examples, each insert 125 also is sized to receive a sleeve 105 of a particular size (e.g., diameter). Accordingly, the same sleeving tool 115 can be used to apply sleeve 105 of different sizes to cable bundles 103 of different sizes by using different insert.

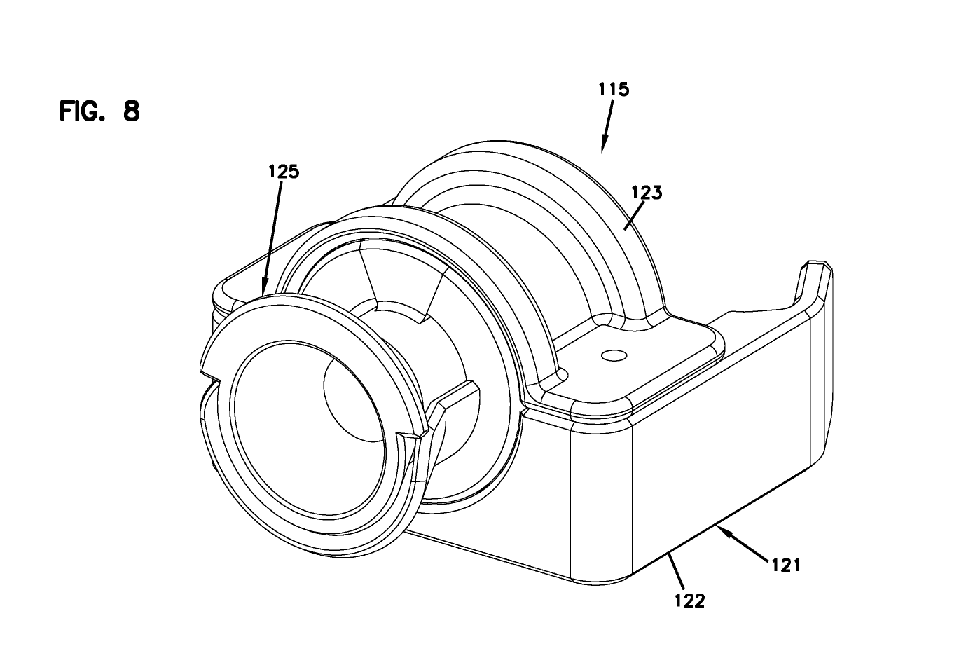

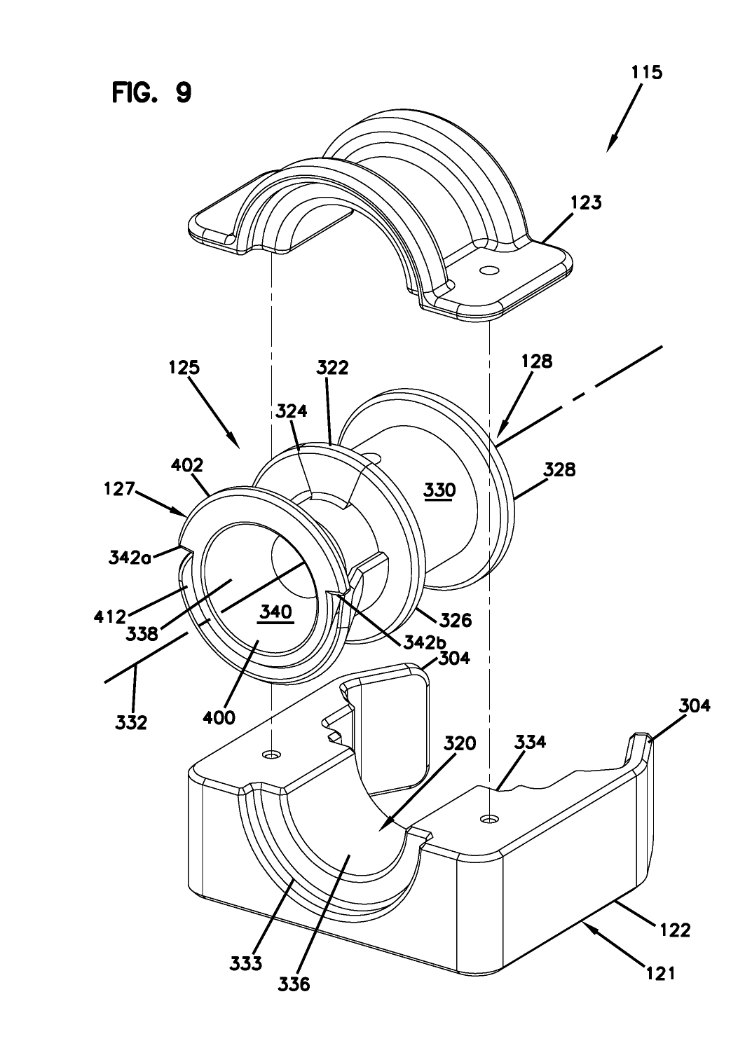

FIGS. 8 and 9 illustrate an example sleeving tool 115. The sleeving tool 115 includes a mounting arrangement 121 configured to hold an insert 125. In the example shown, the mounting arrangement 121 includes first and second mounting members 122, 123 that cooperate to secure the insert 125. In other examples, other types of mounting arrangements can be used to secure the insert 125 to a frame or other structure.

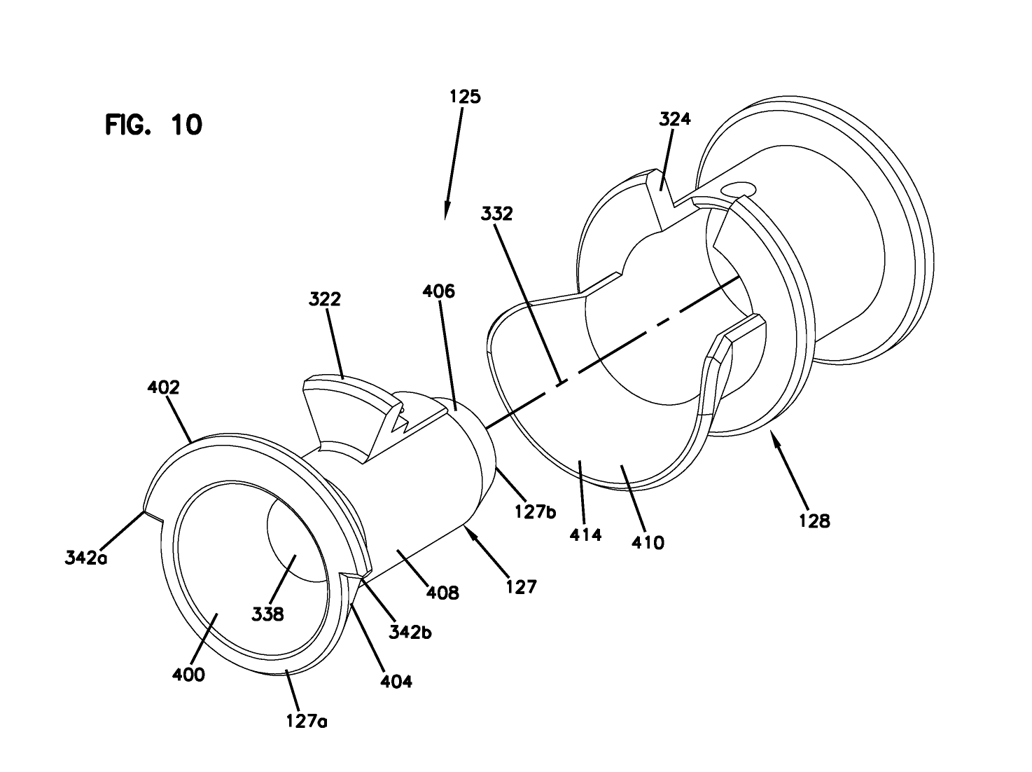

As shown at FIG. 10, the insert 125 includes an inner guide member 127 (e.g., inner conduit) and an outer guide member 128 that are open at a first axial end of the insert 125. The inner guide member 127 and the outer guide member 128 are generally coaxially aligned. In certain implementations, the first axial end of the inner guide member 127 forms a funnel to direct the optical cable bundle 103 into the conduit 127.

The outer guide member 128 is radially spaced from the inner conduit 127 to define a channel therebetween. In certain examples, the channel is a semi-annular channel. In certain examples, the channel is a U-shaped channel. In certain examples, the channel is substantially annular. The sleeve 105 is directed into the channel between the inner guide member 127 and outer guide member 128. Accordingly, the optical cable bundle 103 within the inner guide member 127 is routed within the sleeve 105 disposed in the channel.

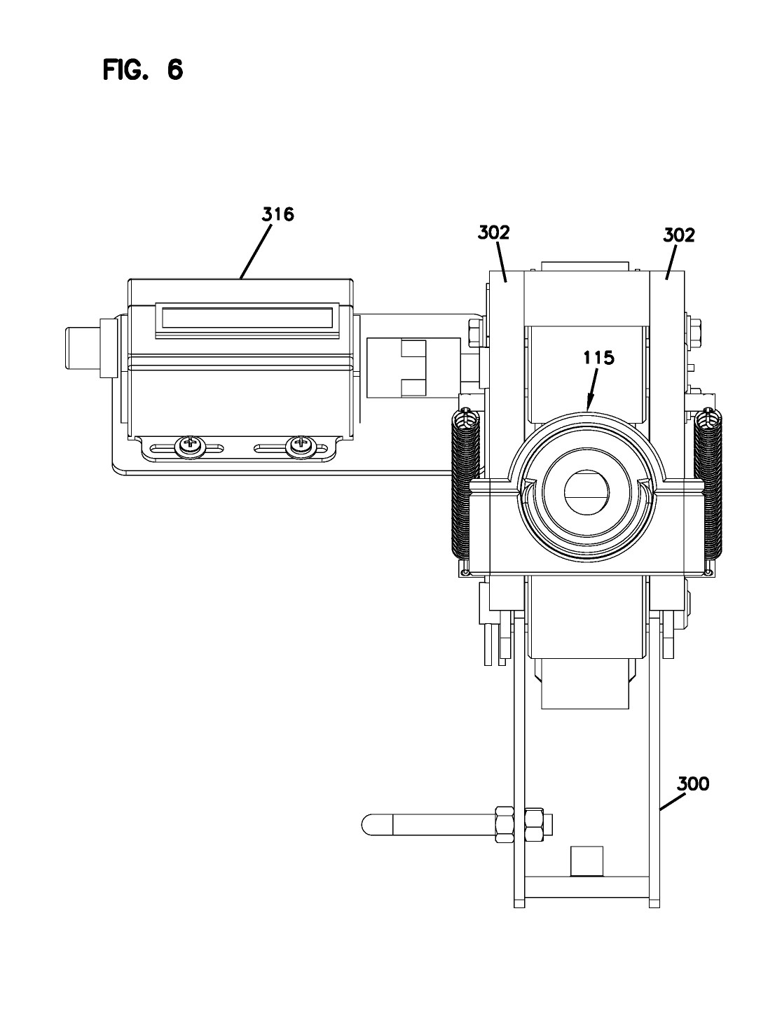

Referring to FIG. 6, the sleeving tool 115 mounts to a frame 300. For example, the frame 300 includes parallel rails 302 to which the sleeving tool 115 mounts. In one example, the sleeving tool 115 includes mounting fingers 304 defining pockets 306 that receive the rails 302. In certain examples, the mounting fingers 304 can snap-fit on the rails 302. In other examples, the mounting fingers 304 can slide onto the rail. In still other examples, rails 302 can be clamped between the mounting fingers 304.

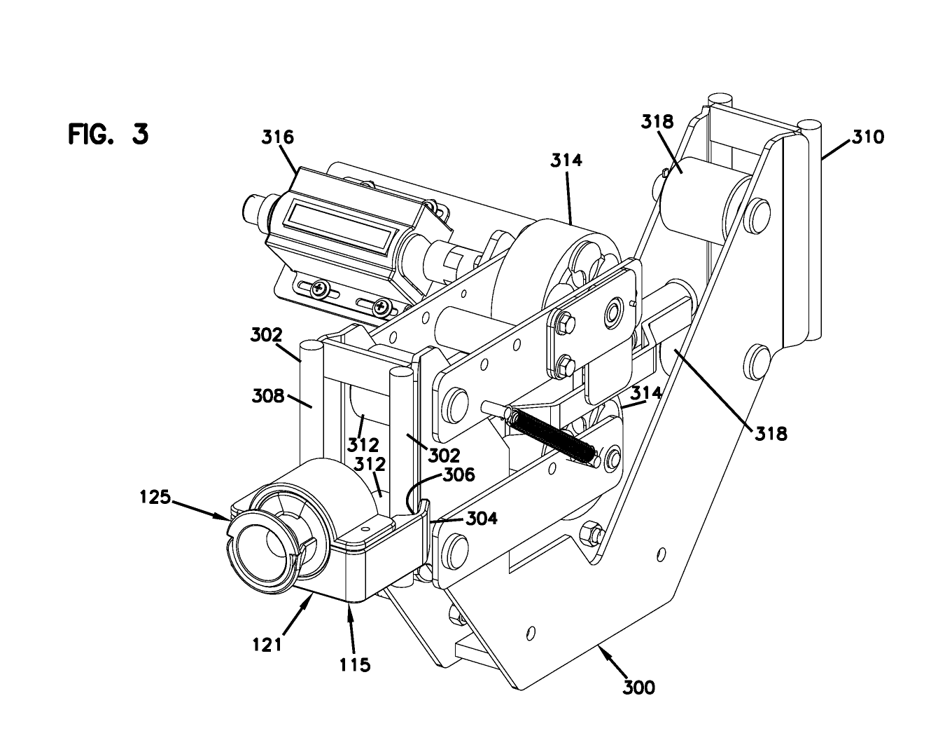

Referring still to FIG. 3, the frame 300 includes an upstream end 308 and a downstream end 310. The sleeving tool 115 mounts at the rails 302 at the upstream end 308. Guide rollers 312 for guiding the sleeved cable arrangement are located immediately downstream from the upstream end 308. The sleeved cable arrangement also passes between counter rollers 314 coupled to a counter 316. The counter 312 is adapted to measure a linear length of sleeved cable that passes between the counter rollers 314. As the sleeved cable passes through the cable rollers 314, the counter rollers 314 rotate so as to actuate the counter 316. The frame 300 also includes guide rollers 318 adjacent the downstream end 310 for guiding the sleeved cable arrangement as the sleeved cable arrangement exits the frame 300. From the guide rollers 318, the sleeved cable arrangement is coiled on the driven spool 118 that functions to pull the sleeved cable arrangement through the sleeving tool 115.

Referring to FIG. 9, the first mounting member 122 defines a cradle 320 for receiving the insert 125. The insert 125 includes a lower portion that mates within the cradle 320. The cradle 320 has a shape that complements the lower portion of the insert 125. In one example, the insert includes axially spaced-apart outer annular flanges, and the cradle 320 includes grooves that receive the flanges. The insert 125 can include an outer cylindrical section between the flanges, and the cradle 320 can include a pocket for receiving the outer cylindrical section. The insert 125 is retained within the cradle 320 of the first mounting member 122 by the second mounting member 123 which functions as a cover. The second mounting member 123 can be fastened to a top side of the first mounting member 122 by fasteners (e.g., bolts, screws, etc.). An interior of the second mounting member 123 has a shape that compliments an outer shape of a top side of the insert 125. Thus, a top portion of the insert 125 is arranged and configured mate within an interior shape of the second mounting member 123. The mounting fingers 304 of the sleeving tool 115 are integrated with the first mounting member 122 of the mounting arrangement 121.

Referring to FIG. 10, the insert 125 has a two-piece construction which includes the inner guide member 127 and the outer guide member 128. The inner guide member 127 fits inside and co-axially aligns with the outer guide member 128. The inner guide member 127 can include a key 322 (e.g., and element such as a wedge-shaped element) that fits within a keyway 324 (e.g., a receptacle such as a wedge-shaped receptacle) defined by the outer guide member 128. In one example, the key and the keyway can be shaped generally in the shape of a sector if a circle (e.g., generally pie-piece shaped). The insert 125 can include two axially spaced-apart outer annular flanges 327, 328 that are separated by a cylindrical section 330. The annular flanges 326, 328 extend around a passage axis 332 along which the outer guide member 128 and the inner guide member 127 are co-axially aligned. The outer guide member 128 defines entire flange 328 and a majority of the annular flange 326. The annular flange 326 defines the keyway 324 and the key 326 forms a portion of the annular flange 326 when the inner and outer guide members 127, 128 are mated together.

When the insert 125 is mounted between the members 122, 123, the annular shoulders 326, 328 fit within corresponding annular recesses 333, 334 (e.g., grooves) defined by the mounting arrangement 121. Also, the mounting arrangement 121 includes a semi-circular pocket 336 (e.g., a cylindrical section) that receives a lower portion of the cylindrical section 330. A portion of the mounting member 122 which defines the semi-circular pocket 336 is captured between the annular flanges 326, 328. In this way, interference between the flanges 326, 328 and the body of the mounting member 122 prevent the insert 125 from moving axially relative to the mounting arrangement 121.

The inner guide member 127 defines an inner passage 338 for receiving the cable or cable bundle desired to the sleeved. The inner passage 338 extends along the passage axis 332 between an upstream end 127a and a downstream end 127b of the inner guide member 127. In certain examples, the inner guide member 127 can include a funnel-shaped section 400 adjacent the upstream end 127a of the inner guide member 127. The funnel-shaped section 400 can be in the shape of a truncated cone (e.g., a full truncated cone or partial truncated cone), a bell-mouth (e.g., a full bell-mouth or partial bell-mouth), a trumpet (e.g., a full trumpet or partial trumpet) or other similar tapered configuration. The inner passage 338 can be defined by an inner surface 340. At the funnel-shaped section 400, the inner surface 340 can form an enlarged mouth that has a tapered configuration such that a cross-dimension CD of the mouth gradually reduces as the mouth extends in a downstream direction.

The inner guide member 127 also includes a flange 402 at the upstream end 127a. In one example, the flange 402 is semi-circular. In one example, the flange 402 extends circumferentially about the passage axis 332 between first and second shoulders 342a, 342b positioned on opposite sides of the inner passage 338. The flange 402 is located at the major end of the funnel-shaped section 400. The shoulders 342a, 342b project outwardly from the funnel-shaped section 400 and define sleeve stops.

The funnel-shaped section 400 of the inner guide member 127 includes an outer sleeve expansion surface 404 that curves circumferentially around the passage axis 332 from the shoulder 342a to the shoulder 342b. In certain examples, the curved path of the sleeve expansion surface 404 from the shoulder 342a to the shoulder 342b extends less than 270° about the passage axis 332, or in the range of 140-220 degrees about the passage axis 332, or in the range of 160-200 degrees about the passage axis 332. The sleeve expansion surface 404 can include a convex curvature as the surface 404 extends circumferentially around the central axis 332. In certain examples, the sleeve expansion surface 404 has a tapered configuration that gradually constricts or reduces as surface 404 extends in a downstream direction. In one example, the sleeve expansion surface 404 corresponding to the funnel-shaped section 400 is defined by a major radius R1 at the major end of the funnel-shaped section 400 and a minor radius R2 at the minor end of the funnel-shaped section 400. The radius defining the sleeve expansion surface 404 gradually decreases in size along the funnel-shaped section 400 as the sleeve expansion surface 404 extends in a downstream direction. In certain examples, the sleeve expansion surface 404 has a partial truncated conical configuration, a partial bell-shaped configuration or a partial trumpet shaped configuration.

The inner guide member 127 also includes a necked-down section 406 positioned at the downstream end 127b of the inner guide member and a cylindrical section 408 that extends between the funnel-shaped section 400 and the necked-down section 406. The sleeve expansion surface 404 is cylindrical along the cylindrical section 408 and the sleeve expansion surface tapers down along the necked-down section 406.

The outer guide member 128 surrounds at least a portion of the inner guide member 127 when the insert 125 is assembled. With the inner and outer guide members 127, 128 assembled together, a sleeve containment surface 410 of the outer guide member 128 that opposes the sleeve expansion surface 404 of the inner guide member 127. The outer sleeve expansion surface 404 of the inner guide member 127 and the sleeve containment surface 410 of the outer guide member 128 cooperate to define a sleeve passage 412 that extends axially through the insert 125 in an upstream to downstream direction. At the upstream end of the inner guide member 127, the sleeve passage has a transverse cross-sectional shape that curves generally about the passage axis 332 from the shoulder 342a to the shoulder 342b. At the upstream end of the inner guide member 127, the sleeve passage 412 extends less than 270 degrees about the passage axis 332, or in the range of 140-220 degrees about the passage axis 332, or in the range of 160-200 degrees about the passage axis 332.

The outer guide member 128 includes an enlarged mouth 414 at its upstream end which is adapted to surround and oppose the portion of the sleeve expansion surface 404 coinciding with the funnel-shaped section 400 of the inner guide member 127. The enlarged mouth can configured generally in the shape of a partial truncated cone, a partial bell-mouth, a partial trumpet or any other type of partial funnel structure that tapers inwardly as the structure extends in a downstream direction. The mouth 414 defines an upstream section of the sleeve containment surface 410. The outer guide member 128 also includes funnel section 416 that opposes the necked-down section 406 of the inner guide member 127 and a cylindrical section 418 (e.g., a partial cylinder and/or a full cylinder) that surrounds and opposes the cylindrical section 408 of the inner guide member 127.

As described above, the key 322 of the inner guide member 127 has a wedge-shaped profile that nests with the corresponding wedge-shaped keyway 423 of the outer guide member 128. The nested relationship between the key 322 and the keyway 324 assists in maintaining the inner guide member 127 at a fixed radial position relative to the outer guide member 128. As so positioned, a bottom side of the inner guide member 127 is upwardly offset from the sleeve containment surface 410 of the outer guide member 128. Thus, the arcuate sleeve passage 412 is defined between the inner guide member 127 and the outer guide member 128.

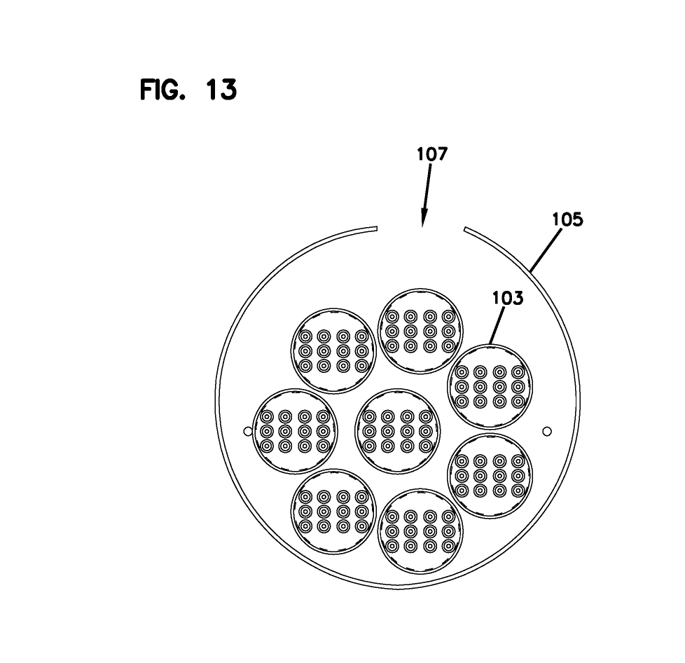

At the upstream end of the insert 125, the sleeve passage 412 has a curvature defined by a relatively large radius R1. The radius R1 is larger than the radius of the split sleeve when the split sleeve is in the closed orientation. Thus, to fit within the sleeve passage 412 at the upstream end of the insert 125, the split sleeve 105 must be flexed open as shown at FIG. 12 to fit over the major end of the funnel-shaped section 400. As the sleeve passage 412 extends in a downstream direction from the upstream end of the insert 125, the radius of the sleeve passage 412 gradually reduces to a radius R2 such that the split sleeve 105 elastically closes around the inner conduit piece 127 as the split sleeve 105 moves through the sleeve passage 412 (see FIG. 13). Adjacent the downstream end of the insert 125, the radius of the sleeve passage 412 further reduces thereby allowing the split sleeve 105 to completely close or almost completely close about the cable as the cable or cable bundle exits the inner passage of the inner member 127 at the downstream end 127b of the inner guide member 127 (see FIG. 1). In certain examples, the downstream end 127b of the inner guide member 127 is offset in an upstream direction from a downstream end of the outer guiding member 128.

In use of the coiling system 110, the sleeving tool 115 is mounted to the upstream end of the frame by the mounting assembly 121. The split sleeve 105 is directed into the sleeve passage 412 of the sleeving tool 115 and the cable or cable bundle 103 is routed through the inner passage 338 of the sleeving tool 115. Preferably, the split sleeve 105 and the cable/cable bundle 103 are moved axially through the sleeving tool 115 at the same speed. The split sleeve 105 is forced open at the upstream end of the sleeving tool 115 by the enlarged end of the funnel-shaped section 400 of the inner guide member 127. As the split sleeve 105 moves through the sleeving tool in an upstream to downstream direction, the split sleeve 105 gradually closes around the inner conduit piece 127 by its own elasticity following the outer contour of the inner guide member 127. Upon exiting the sleeving tool 115, the split sleeve 105 fully closes around the cable/cable bundle 103 which exits the downstream end of the inner guide member 127. The sleeved cable passes between the counter rollers and exits the downstream end of the frame. The sleeved cable is then coiled upon the driven spool 118. In a preferred automated system, the split sleeve 105 and the cable 103 are pulled though the sleeving tool 115 and the counter rollers by force generated by the powered drive that drives rotation of the driven spool 118 about which the sleeved cable is coiled for storage. Thus, as the driven spool 118 is rotated to coil the sleeved cable about the driven spool 118, the split sleeve 105 and cable/cable bundle 103 are concurrently pulled through the sleeving tool 115 causing the cable/cable bundle 103 to be loaded within the split sleeve 105 prior to passing between the counter rollers.

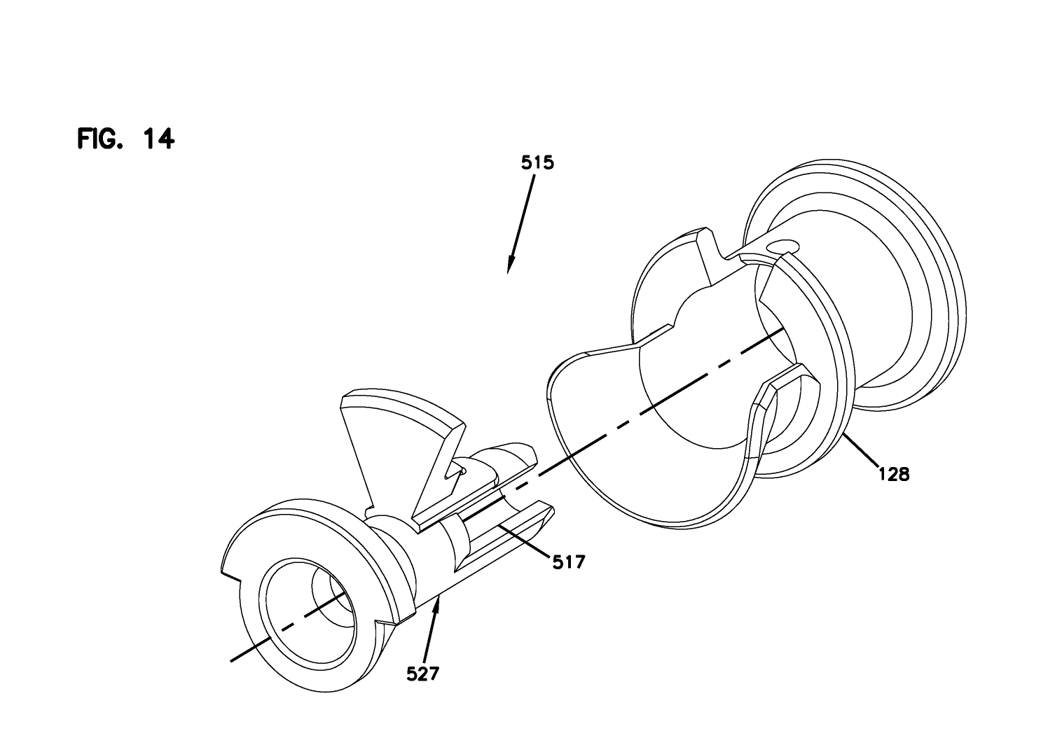

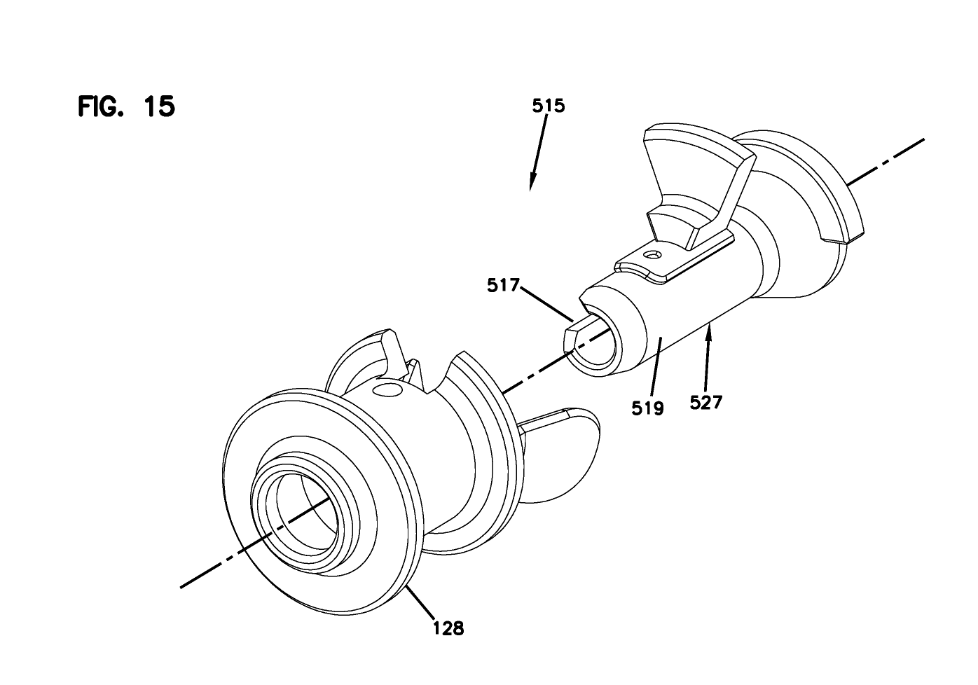

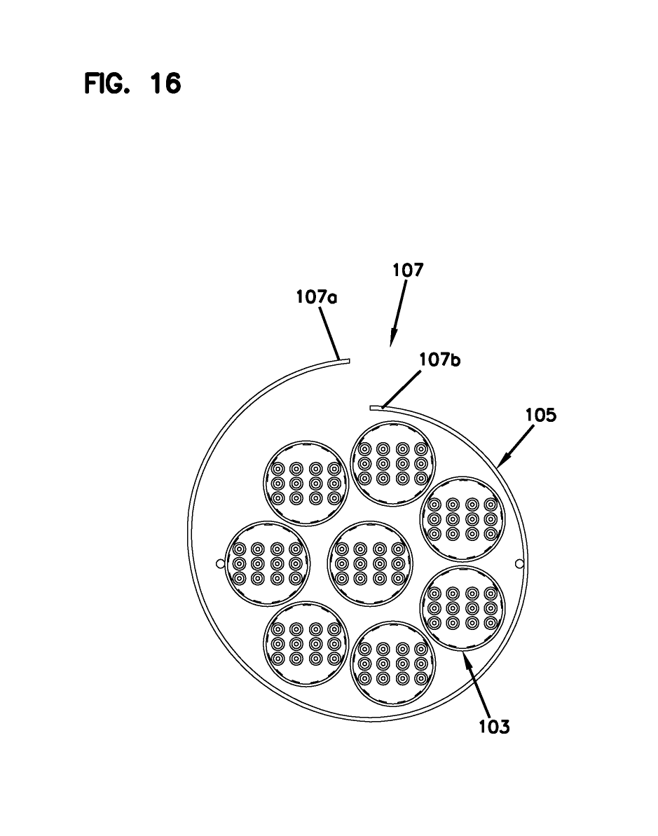

FIGS. 14 and 15 show another sleeving tool 515 in accordance with the principles of the present disclosure. The sleeving tool 515 is configured to insure that the underlap portion 107b of the split sleeve seam 107 tucks under the overlap portion 107a of the split sleeve seam 107 during the sleeving process. FIG. 16 shows the sleeved cable bundle of FIG. 1 passing through the sleeving tool of FIGS. 14 and 15 with the underlap portion 107b of the split sleeve seam 107 shown returned (e.g., laid down, moved down, etc.) to the closed position prior to the overlap portion of the split sleeve being allowed to return to the closed position (i.e., the overlap portion is retained in the flexed-open orientation while at the same time the underlap portion is allowed to return to the closed position). In the example of FIG. 14, an inner guide member 527 has a downstream end with an asymmetric configuration having a first portion for retaining the overlap portion 107a expanded and a second portion for allowing the underlap portion 107b to move to the closed position. The first and second portions can coincide with the same axial position of the inner guide member such that the first portion supports the overlap portion 107a in the flexed-open position while the underlap portion 107b concurrently moves across the second portion such the underlap portion 107b is no longer held in the flexed-open position and elastically returns to the closed position. The overlap portion 107a subsequently moves axially past the first portion and closes over the previously closed underlap portion 107b. As depicted at FIGS. 14 and 15, the second portion is defined by a cut-away portion 517 at one side of the downstream end of the inner guide member 527 and the first portion is defined by a support surface 519 at an opposite side of the inner guide member 527. The second portion can be a region where the sleeve support surface has been eliminated or a region where the sleeve support surface is recessed relative to an axially coincident support surface on an opposite side of the inner guide member 527. It will be appreciated that other features of the inner guide member 527 can be the same as the inner guide member 127, and that the inner guide member 527 can be inserted in the outer guide member 128 in the same manner as the inner guide member 127.

Another aspect of the present disclosure relates to a cable sleeving tool for applying a split-sleeve over a cable structure. The cable sleeving tool includes an inner guide member defining an inner passage for receiving a cable structure desired to be sleeved. The inner passage extends along a passage axis between an upstream end of the inner guide member and a downstream end of the inner guide member. The inner guide member includes an inner surface defining the inner passage and an outer sleeve expansion surface for expanding the split sleeve. The cable sleeving tool also includes an outer guide member that surrounds at least a portion of the inner guide member. The outer guide member includes a sleeve containment surface that opposes the outer sleeve expansion surface. The outer sleeve expansion surface and the sleeve containment surface cooperate to define a sleeve passage having a transverse cross-sectional shape that curves generally about the passage axis.

In one example, the transverse cross-sectional shape of the sleeve passage curves less than or equal to 270 degrees about the passage axis adjacent an upstream end of the sleeve passage. In another example, the transverse cross-sectional shape of the sleeve passage curves 140-220 degrees about the passage axis adjacent an upstream end of the sleeve passage. In still another example, the transverse cross-sectional shape of the sleeve passage curves 160-200 degrees about the passage axis adjacent an upstream end of the sleeve passage. In certain examples, the transverse cross-sectional shape of the sleeve passage curves 360 degrees about the passage axis adjacent a downstream end of the sleeve passage.

In certain examples, a sleeving tool in accordance with the principles of the present disclosure includes an inner guide member defining an inner passage that extends along a passage axis, and having a funnel-shaped section adjacent an upstream end of the inner guide member. The funnel-shaped section can taper inwardly toward the passage axis as the funnel-shaped section extends in a downstream direction along the passage axis. The sleeving tool can also include an outer guide member including an upstream enlarged mouth that tapers inwardly as the enlarged mouth extends in a downstream direction, the enlarged mount coinciding generally axially with the funnel-shaped section of the inner guide member such that a sleeve passage is defined between the funnel-shaped section and the enlarged mouth. The inner guide member can include a flange at the upstream end, the flange defining sleeve stops at opposite ends of the transverse cross-sectional shape of the sleeve passage.

Having described the preferred aspects and implementations of the present disclosure, modifications and equivalents of the disclosed concepts may readily occur to one skilled in the art. However, it is intended that such modifications and equivalents be included within the scope of the present disclosure.

What is claimed is:

1. A cable sleeving tool for applying a split-sleeve over a cable structure, the cable sleeving tool comprising:
an inner guide member defining an inner passage for receiving a cable structure desired to be sleeved, the inner passage extending along a passage axis between an upstream end of the inner guide member and a downstream end of the inner guide member, the inner guide member including an inner surface defining the inner passage and an outer sleeve expansion surface for expanding the split sleeve; and
an outer guide member that surrounds at least a portion of the inner guide member, the outer guide member including a sleeve containment surface that opposes the outer sleeve expansion surface, the outer sleeve expansion surface and the sleeve containment surface cooperating to define a sleeve passage having a transverse cross-sectional shape that curves generally about the passage axis.

2. The cable sleeving tool of claim 1, wherein the transverse cross-sectional shape curves less than or equal to 270 degrees about the passage axis adjacent an upstream end of the sleeve passage.

3. The cable sleeving tool of claim 1, wherein the transverse cross-sectional shape curves 140-220 degrees about the passage axis adjacent an upstream end of the sleeve passage.

4. The cable sleeving tool of claim 1, wherein the transverse cross-sectional shape curves 160-200 degrees about the passage axis adjacent an upstream end of the sleeve passage.

5. The cable sleeving tool of claim 1, wherein the transverse cross-sectional shape curves 360 degrees about the passage axis adjacent a downstream end of the sleeve passage.

6. The cable sleeving tool of claim 1, wherein the inner guide member includes a funnel-shaped section adjacent the upstream end of the inner guide member, the funnel-shaped section tapering inwardly toward the passage axis as the funnel-shaped section extends in a downstream direction along the passage axis.

7. The cable sleeving tool of claim 6, wherein the inner guide member includes a flange at the upstream end, the flange defining sleeve stops at opposite ends of the transverse cross-sectional shape of the sleeve passage.

8. The cable sleeving tool of claim 6, wherein the outer guide member includes an upstream enlarged mouth that tapers inwardly as the enlarged mouth extends in a downstream direction, the enlarged mount coinciding generally axially with the funnel-shaped section of the inner guide member.

9. The cable sleeving tool of claim 8, wherein the enlarged mouth curves around the passage axis less than or equal to 270 degrees.

10. The cable sleeving tool of claim 8, wherein the enlarged mouth curves 140-220 degrees around the passage axis.

11. The cable sleeving tool of claim 8, wherein the enlarged mouth curves 160-200 degrees around the passage axis.

12. The cable sleeving tool of claim 8, wherein the enlarged mouth forms generally half a truncated cone, generally half a bell mouth, or generally half a trumpet shape.

13. The cable sleeving tool of claim 1, wherein the inner guide member includes an upstream mouth including a full truncated cone, a full bell-mouth shaped section or a full trumpet shaped section adjacent the upstream end of the inner guide member, the upstream mouth tapering inwardly toward the passage axis as the upstream mouth extends in a downstream direction along the passage axis.

14. The cable sleeving tool of claim 1, wherein the inner guide member has an upstream end portion and a downstream end portion, the upstream end portion that defining a transverse cross-dimension that is larger than a transverse cross-dimension defined by the downstream end portion.

15. The cable sleeving tool of claim 1, wherein the inner guide member includes a wedge-shaped element that nests within a wedge-shaped receptacle defined by the outer guide member.

16. The cable sleeving tool of claim 15, wherein the wedge-shaped element has a shape that is generally in the shape of a sector of a circle.

17. The cable sleeving tool of claim 16, wherein the outer guide member includes axially spaced-apart outer annular flanges that extend around the passage axis when the inner and outer guide members are connected together, and wherein the wedge-shaped receptacle is defined within one of the outer annular flanges.

18. The cable sleeving tool of claim 1, wherein the inner and outer guide members mate together to form an insert, and wherein the insert mounts within a mounting arrangement that includes first and second mounting members.

19. The cable sleeving tool of claim 18, wherein the first mounting member includes a cavity for receiving the inert, wherein the second mounting member is a cover that mounts over the insert and retains the insert within the cavity, and wherein the first mounting members includes fingers for attaching the mounting arrangement to rails.

20. The cable sleeving tool of claim 19, wherein the insert includes axially spaced-apart outer annular flanges, and wherein the receptacle includes grooves for receiving the axially spaced-apart outer annular flanges.

21. A sleeving tool comprising:
a tool base; and
an insert arrangement including:
a mounting arrangement; and
a replaceable insert held by the mounting arrangement, the replaceable insert including an inner conduit defining a passage, the replaceable insert also including a guiding member that defines a channel between the inner conduit and the guiding member.

22. A sleeving system comprising:
a first spool holding a bundle of optical cables;
a second spool holding a length of sleeve;
a sleeving tool configured to automatically apply the sleeve around the bundle of optical cables to form a sleeved cable; and
a take-up spool that holds the sleeved cable.

23. The sleeving system of claim 22, wherein the sleeving tool includes a mounting arrangement configured to receive one of a plurality of replaceable inserts, each replaceable insert configured to receive a particular size of the sleeve and bundle of optical cables.
